(19) United States
(12) Patent Application Publication
(10) Pub. No.: US 2026/0338954 A1
(43) Pub. Date: Oct. 29, 2026

(54) 3-D ULTRAVIOLET LASER SCANNER

(71) Applicants: Sony Group Corporation, Tokyo (JP); Sony Pictures Entertainment Inc., Culver City, CA (US)

(72) Inventor: Gregory Hodges, Dripping Springs, TX (US)

(21) Appl. No.: 19/193,779

(22) Filed: Apr. 29, 2025

(51) Int. Cl. G01S 17/89; G01S 7/481

(52) U.S. Cl. CPC G01S 17/89; G01S 7/4813; G01S 7/4814; G01S 7/4817

(57) ABSTRACT

A UV laser scanner to perform 3-D scan of objects, including: at least one stepper motor; a housing unit including a UV laser and a UV sensor, wherein the at least one stepper motor moves in discrete steps for precise 3-D positioning of the housing unit by generating pitch and yaw movements to orient the UV laser and the UV sensor to cover a 360-degree field of view; and a processor to trigger the UV laser to illuminate the objects with UV laser light, wherein the processor receives digital data of return signal sensed by the UV sensor and determines a depth of the objects by checking a time delta between triggering of the UV laser and receipt of the return signal sensed by the UV sensor.

### BACKGROUND

### Field

The present disclosure relates to laser scanners, and more specifically to 3-D ultraviolet (UV) point scanners.

### Background

Typically, a 3-D laser scanner is used to capture a point cloud, which is a collection of points in 3-D space, typically representing the surface or shape of an object or environment. Each point in the cloud is defined by its X, Y, and Z coordinates, and can also contain additional data like color, intensity, or normals. The 3-D laser scanner steers a beam of light to a target such as a diffusely scattering surface of an object. A sensor measures a distance to the object, and angular encoders measure the angles of rotation of two axles. The measured distance and two angles enable a processor to determine the 3-D coordinates of the target.

A key issue with conventional 3-D laser scanners is that they cannot detect glass, since glass is invisible in the optical range of the laser. Further, these scanners may not be able to detect mirrors, gold, or polished copper, since the laser light bounces away from the sensor rather than toward it.

### SUMMARY

The present disclosure provides for 3-D UV point scanners to perform 3-D scan of objects.

In one implementation, a UV laser scanner to perform 3-D scan of objects is disclosed. The UV laser scanner includes: at least one stepper motor; a housing unit including a UV laser and a UV sensor, wherein the at least one stepper motor moves in discrete steps for precise 3-D positioning of the housing unit by generating pitch and yaw movements to orient the UV laser and the UV sensor to cover a 360-degree field of view; and a processor to trigger the UV laser to illuminate the objects with UV laser light, wherein the processor receives digital data of return signal sensed by the UV sensor and determines a depth of the objects by checking a time delta between triggering of the UV laser and receipt of the return signal sensed by the UV sensor.

In another implementation, a UV laser scanner is disclosed. The UV laser scanner includes: a stepper motor configured with a dual-motor controller including first and second drivers; a sensor/laser housing unit coupled to the stepper motor, the sensor/laser housing unit including a UV laser and a UV sensor, the UV laser to illuminate objects with UV laser light and the UV sensor to sense return signal from the objects, wherein the first driver generates pitch movement of the sensor/laser housing unit, and the second driver generates yaw movement of the sensor/laser housing unit; and a processor to receive digital data based on the return signal from the UV sensor and perform 3-D scan of the objects using the digital data.

In yet another implementation, a UV laser scanner is disclosed. The UV laser scanner includes: a first stepper motor; a second stepper motor; a sensor/laser housing unit coupled to the first and second stepper motors, the sensor/laser housing unit including a UV laser and a UV sensor, the UV laser to illuminate objects with UV laser light and the UV sensor to sense return signal from the objects, wherein the first stepper motor generates pitch movement of the sensor/laser housing unit, and the second stepper motor generates yaw movement of the sensor/laser housing unit; and a processor to receive digital data based on the return signal from the UV sensor and perform 3-D scan of the objects using the digital data.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a block diagram of a UV laser scanner in accordance with one implementation of the present disclosure;

FIG. 2A is a block diagram illustrating a UV laser scanner in accordance with one implementation of the present disclosure; and

FIG. 2B is a block diagram illustrating a UV laser scanner in accordance with another implementation of the present disclosure.

### DETAILED DESCRIPTION

As described above, the problem with a conventional 3-D laser scanner is that it may not be able to detect glass, mirrors, gold, or polished copper due to its optical characteristics.

Certain implementations of the present disclosure provide for a 3-D ultraviolet (UV) “point” scanner (hereafter referred to as UV laser scanner) including a UV laser, a UV sensor, at least one stepper motor, and a processor. After reading below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

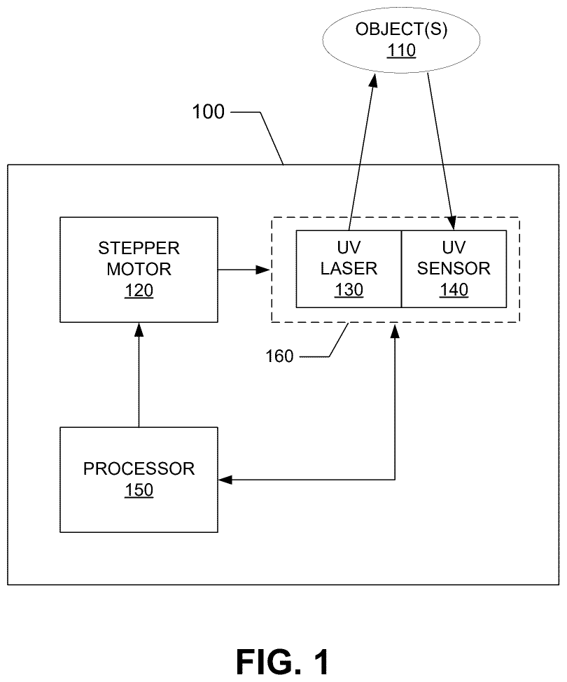

FIG. 1 is a block diagram of a UV laser scanner 100 in accordance with one implementation of the present disclosure. In the illustrated implementation of the FIG. 1, the UV laser scanner 100 includes at least one stepper motor 120, a sensor/laser housing unit 160 including a UV laser 130 and a UV sensor 140, and a processor 150. The stepper motors move in discrete steps to make them suitable for precise positioning.

In one implementation, the UV laser scanner 100 operates to capture a detailed, digital representation of object(s) or environment 110 (hereinafter referred to as “objects”) in 3-D and generate point cloud data including representation of both clear and opaque objects including glass, mirrors, gold, or polished copper objects. The UV laser scanner 100 is able to do this by emitting UV laser beams and measuring the time it takes for the beams to bounce back, allowing the scanner to calculate precise distances and orientations. The point cloud data may then be used for various applications, including architectural design, reverse engineering, and creating digital twins of physical objects.

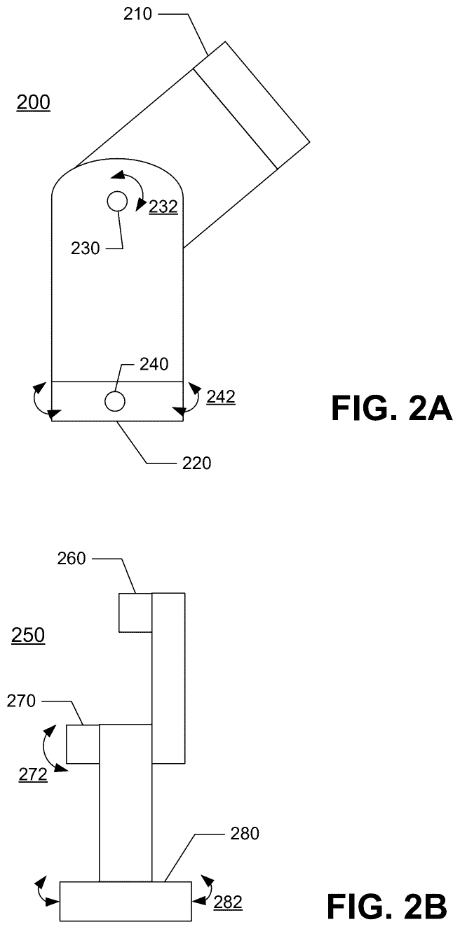

In one implementation, the at least one stepper motor 120 includes two stepper motors (see FIG. 2B), one that rotates vertically (e.g., providing pitch movements) and another that rotates horizontally (e.g., providing yaw movements). In this implementation, using two stepper motors for pitch and yaw movements involves controlling each motor independently to achieve desired rotations around the respective axes. Thus, the pitch and yaw movements of the at least one stepper motor 120 enable the UV laser scanner 100 to orient the UV laser 130 and the UV sensor 140 to cover a 360-degree field of view. In another implementation, the at least one stepper motor 120 includes a dual-motor controller (see FIG. 2A) having two outputs for two separate drivers, one driver per motor.

In the illustrated implementation of the FIG. 1, the UV laser 130 and the UV sensor 140 are configured to operate in the UV range of light. In one implementation, the stepper motor 120 drives the sensor/laser housing unit 160 into position and the processor 150 triggers the UV laser 130 to illuminate the objects 110 with UV laser. The UV sensor 140 sense the return UV signal from the objects 110 and sends the sensed signal as digital data to the processor 150. The processor 150 determines the depth of the object by checking the time delta between triggering of the UV laser and receipt of the sensed signal.

FIG. 2A is a block diagram illustrating a UV laser scanner 200 in accordance with one implementation of the present disclosure. In the illustrated implementation of FIG. 2A, the UV laser scanner 200 includes a sensor/laser housing unit 210 coupled to a stepper motor configured with a dual-motor controller 220. In this implementation, the dual motor controller 220 includes two outputs for two separate drivers, one to drive a first driver 230 for a pitch movement 232 and another to drive a second driver 240 for a yaw movement 242. Thus, the pitch and yaw movements 232, 242 of the stepper motor 220 enable the UV laser scanner 200 to orient the sensor/laser housing unit 210 to cover a 360-degree field of view.

FIG. 2B is a block diagram illustrating a UV laser scanner 250 in accordance with another implementation of the present disclosure. In the illustrated implementation of FIG. 2B, the UV laser scanner 250 includes a sensor/laser housing unit 260 coupled to two stepper motors 270, 280. In this implementation, the stepper motor 270 generates a pitch movement 272, while the stepper motor 280 generates a yaw movement 282. Thus, the pitch and yaw movements 272, 282 of the two stepper motors 270, 280 enable the UV laser scanner 250 to orient the sensor/laser housing unit 260 to cover a 360-degree field of view.

In a particular implementation, a UV laser scanner to perform 3-D scan of objects is disclosed. The UV laser scanner includes: at least one stepper motor; a housing unit including a UV laser and a UV sensor, wherein the at least one stepper motor moves in discrete steps for precise 3-D positioning of the housing unit by generating pitch and yaw movements to orient the UV laser and the UV sensor to cover a 360-degree field of view; and a processor to trigger the UV laser to illuminate the objects with UV laser light, wherein the processor receives digital data of return signal sensed by the UV sensor and determines a depth of the objects by checking a time delta between triggering of the UV laser and receipt of the return signal sensed by the UV sensor.

In one implementation, the processor uses the digital data of the return signal to generate point cloud data including representation of the objects. In one implementation, the objects include both clear, opaque objects, and reflective objects including at least one of glass, mirrors, gold, and polished copper objects. In one implementation, the point cloud data is used for architectural design, reverse engineering, or creating digital twins of physical objects. In one implementation, the at least one stepper motor includes two stepper motors, wherein a first stepper motor rotates vertically to provide pitch movements and a second stepper motor rotates horizontally to provide yaw movements. In one implementation, using the two stepper motors for pitch and yaw movements involves controlling each motor independently to achieve desired rotations around respective axes. In one implementation, the at least one stepper motor includes a dual-motor controller having two outputs for two separate drivers.

In another particular implementation, a UV laser scanner is disclosed. The UV laser scanner includes: a stepper motor configured with a dual-motor controller including first and second drivers; a sensor/laser housing unit coupled to the stepper motor, the sensor/laser housing unit including a UV laser and a UV sensor, the UV laser to illuminate objects with UV laser light and the UV sensor to sense return signal from the objects, wherein the first driver generates pitch movement of the sensor/laser housing unit, and the second driver generates yaw movement of the sensor/laser housing unit; and a processor to receive digital data based on the return signal from the UV sensor and perform 3-D scan of the objects using the digital data.

In one implementation, the dual motor controller outputs a first signal to drive the first driver and a second signal to drive the second driver. In one implementation, the dual-motor controller enable the UV laser scanner to orient the sensor/laser housing unit to cover a 360-degree field of view.

In yet another particular implementation, a UV laser scanner is disclosed. The UV laser scanner includes: a first stepper motor; a second stepper motor; a sensor/laser housing unit coupled to the first and second stepper motors, the sensor/laser housing unit including a UV laser and a UV sensor, the UV laser to illuminate objects with UV laser light and the UV sensor to sense return signal from the objects, wherein the first stepper motor generates pitch movement of the sensor/laser housing unit, and the second stepper motor generates yaw movement of the sensor/laser housing unit; and a processor to receive digital data based on the return signal from the UV sensor and perform 3-D scan of the objects using the digital data.

In one implementation, the first and second stepper motors enable the UV laser scanner to orient the sensor/laser housing unit to cover a 360-degree field of view.

The description herein of the disclosed implementations is provided to enable any person skilled in the art to make or use the present disclosure. Numerous modifications to these implementations would be readily apparent to those skilled in the art, and the principals defined herein can be applied to other implementations without departing from the spirit or scope of the present disclosure. Thus, the present disclosure is not intended to be limited to the implementations shown herein but is to be accorded the widest scope consistent with the principal and novel features disclosed herein.

Various implementations of the present disclosure are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a persistent storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the application and design constraints imposed on the overall system. Skilled persons can implement the described functionality in varying ways for each application, but such implementation decisions should not be interpreted as causing a departure from the scope of the present disclosure. In addition, the grouping of functions within a module or step is for ease of description. Specific functions can be moved from one module or step to another without departing from the present disclosure.

All features of each above-discussed example are not necessarily required in a particular implementation of the present disclosure. Further, it is to be understood that the description and drawings presented herein are representative of the subject matter that is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A UV laser scanner to perform 3-D scan of objects, the UV laser scanner comprising:
at least one stepper motor;
a housing unit including a UV laser and a UV sensor,
wherein the at least one stepper motor moves in discrete steps for precise 3-D positioning of the housing unit by generating pitch and yaw movements to orient the UV laser and the UV sensor to cover a 360-degree field of view; and
a processor to trigger the UV laser to illuminate the objects with UV laser light,
wherein the processor receives digital data of return signal sensed by the UV sensor and determines a depth of the objects by checking a time delta between triggering of the UV laser and receipt of the return signal sensed by the UV sensor.

2. The scanner of claim 1, wherein the processor uses the digital data of the return signal to generate point cloud data including representation of the objects.

3. The scanner of claim 2, wherein the objects include both clear, opaque objects, and reflective objects including at least one of glass, mirrors, gold, and polished copper objects.

4. The scanner of claim 2, wherein the point cloud data is used for architectural design, reverse engineering, or creating digital twins of physical objects.

5. The scanner of claim 1, wherein the at least one stepper motor includes two stepper motors,
wherein a first stepper motor rotates vertically to provide pitch movements and a second stepper motor rotates horizontally to provide yaw movements.

6. The scanner of claim 5, wherein using the two stepper motors for pitch and yaw movements involves controlling each motor independently to achieve desired rotations around respective axes.

7. The scanner of claim 1, wherein the at least one stepper motor includes a dual-motor controller having two outputs for two separate drivers.

8. A UV laser scanner, comprising:
a stepper motor configured with a dual-motor controller including first and second drivers;
a sensor/laser housing unit coupled to the stepper motor, the sensor/laser housing unit including a UV laser and a UV sensor, the UV laser to illuminate objects with UV laser light and the UV sensor to sense return signal from the objects,
wherein the first driver generates pitch movement of the sensor/laser housing unit, and the second driver generates yaw movement of the sensor/laser housing unit; and
a processor to receive digital data based on the return signal from the UV sensor and perform 3-D scan of the objects using the digital data.

9. The scanner of claim 8, wherein the dual motor controller outputs a first signal to drive the first driver and a second signal to drive the second driver.

10. The scanner of claim 8, wherein the dual-motor controller enable the UV laser scanner to orient the sensor/laser housing unit to cover a 360-degree field of view.

11. A UV laser scanner, comprising:
a first stepper motor;
a second stepper motor;
a sensor/laser housing unit coupled to the first and second stepper motors,
the sensor/laser housing unit including a UV laser and a UV sensor, the UV laser to illuminate objects with UV laser light and the UV sensor to sense return signal from the objects,
wherein the first stepper motor generates pitch movement of the sensor/laser housing unit, and the second stepper motor generates yaw movement of the sensor/laser housing unit; and
a processor to receive digital data based on the return signal from the UV sensor and perform 3-D scan of the objects using the digital data.

12. The scanner of claim 10, wherein the first and second stepper motors enable the UV laser scanner to orient the sensor/laser housing unit to cover a 360-degree field of view.
